(19) United States
(12) Patent Application Publication
(10) Pub. No.: US 2012/0286110 A1
(43) Pub. Date: Nov. 15, 2012

(54) CONDUIT SUPPORT

(76) Inventor: Douglas C. Hill, Brook Park, OH (US)

(21) Appl. No.: 13/467,197

(22) Filed: May 9, 2012

Related U.S. Application Data
(60) Provisional application No. 61/484,300, filed on May 10, 2011.

(51) Int. Cl. F16L 3/10

(52) U.S. Cl. 248/74.2

(57) ABSTRACT

A conduit support for securing conduits to a U-shaped channel having rectangular cross-sectional configuration formed by three faces generally including a base face, a first and a second side face having distal ends that partially define a channel opening. The conduit support having a base plate having an outwardly and inwardly facing sides that extend along a plate axis between a first and second plate ends, the base plate further including a locking clip extending from the inwardly facing side and having opposing clip fingers configured to penetrate the channel opening of the channel and lockingly engage with the channel thereby securing the support relative to the channel such that the inwardly facing side of the base plate faces the first and second distal ends of the channel. The conduit support further including at least one conduit clip shaped to receive and secure a conduit relative to the channel.

This application claims priority in provisional patent application Ser. No. 61/484,300 that was filed on May 10, 2011 and which is incorporated by reference herein in its entirety.

The invention of this application relates to the construction industry and the mounting of electrical wiring and other conduits to a structure. More particularly, to a mounting system that can be used in connection with flexible armored electrical cable of all varieties (including or MC cable) and other conduits hereinafter all referred to as conduits to support these conduits relative to a structural object. In particular, according to the primary set of embodiments, to a structural U-Channel used in the construction of a building.

### INCORPORATION BY REFERENCE

The present invention relates to electrical wiring other conduits and, more particularly, for a mounting system for securing and supporting these conduit to a structural component of a facility. Coleman et al 5,189,719 discloses a rectangular flexible armored cable; Falciglia et al RE38,345 discloses a round flexible armored cable; and Dollins et al. 6,825,418 discloses a coded flexible armored cable. These patents are incorporated by reference herein as background information illustrating flexible armored cables including MC style cables and form part of this specification. Temblador 6,486,395 discloses a flexible armored cable with a special wiring configuration to illustrate that the invention of this application can be used in connection with all flexible armored cable, regardless of the wire gauge and/or wire configuration in the flexible armored cable, and is also incorporated by reference herein as background information and forms part of this specification. This application also incorporates by reference U.S. Pat. No. 7,608,782 and U.S. Pat. No. 7,456,361, all of which are incorporated by reference herein and form part of this specification. Also incorporated by reference is Pat. No. 3,417,951 that discloses a U-Shaped conduit support channel.

### BACKGROUND OF THE INVENTION

The present invention is particularly applicable for use in connection with commercial installation of electrical wiring and plumbing, thus, will be discussed with respect to commercial applications. However, the invention of this application is not to be limited to commercial applications, plumbing and/or wiring. In this respect, many commercial applications require some form of protection of the electrical wiring in a facility. For many years, electricians ran wire through rigid pipes. Now, with the development of flexible armored cable, rigid pipes are not needed. As can be appreciated, this eliminates the step of hanging rigid pipe and pulling the wire through the pipe. Further, since the armor is flexible, it can be easily manipulated around obstacles without jeopardizing the insulated qualities of the wire.

It is, of course, also well known that the electrical wiring in any facility must be insulated and secured to the structure in such a way that the electrical current is controlled and prevented from harming people and property. That is why virtually all electrical wiring sold includes some form of insulation. This can include the thin insulation surrounding the wire core and an outer layer of insulation surrounding the wire insulation. In some cases, the outer layer is made from a material similar to the wire insulation, such as a polymeric material. The wiring can also include a hard outer layer to further protect the wire. This can include the wire having a flexible armored outer layer to protect the wire. While the flexible armored layer is typically made from a metallic material in today's electrical industry, it should be appreciated that the invention of this application could also be used in connection with non-metal flexible armored cables and other cables that could be used or will be used in the electrical industry. In addition, the support of this application can be used with a wide range of conduits including plumbing without detracting from the invention as is mentioned above.

While it has been found that flexible armored cables provide an efficient and effective means for wiring a facility with a protected electrical wire, the flexible armored cable must still be secured to the structure of the facility to be wired. This includes mounting the flexible armored cable to the studs in the facility, the ceiling and other structural members. Further, as can also be appreciated, mounting structures that only require one hand to use can be very beneficial since the other hand can be utilized to guide the cable and/or to maintain one's balance. Likewise, it is also time consuming and costly to install other forms of conduit.

Prior art supports have been created to help secure conduit to structural objects; however, these supports are difficult to use, require tools and both hands. In addition, these prior art supports are costly in that they are expensive and add to the labor cost associated with job. Further prior art devices make it difficult to mount conduits to the ceiling of the job site.

### SUMMARY OF THE INVENTION

In accordance with the present invention, provided is a conduit support that can be easily mounted to a structural object. More particularly, provided is a conduit support that is easily securable to a U-Channel and is configured to allow a conduit to be easily and quickly secured to these and other structural objects.

In this respect, provided is a conduit support for to secure one or more conduits to a construction support, and in particular, to a standard U-shaped metal channel such as a UNISTRUT metal channel that is used in both commercial and residential construction. The metal channel generally has a rectangular cross-sectional configuration and extends linearly along a channel axis between a first and second end, which define a channel length. The U-shaped configuration is formed by three side faces that are at right angles to one another and which can be joined by rounded corner. The three faces include a base face, a first side face and a second side face and the first and second side faces extend from either side of the base face toward a first and a second side distal end respectively. The first and second side distal ends have first and second inwardly curved portions, respectively, that generally extend toward one another and partially define a channel opening that extends linearly between the ends and has an opening axis parallel to and spaced from the channel axis. The first and second distal ends also have flanges extending into an inner space within the U-shaped channel. The conduit support of this application is configured to lockingly engage with the channel opening of the U-shape metal channel and to provide a mounting means for one or more conduits clips that can be attached as desired by electricians, plumbers and the like.

According to certain aspects of the invention of this application, the conduit support is provided with a base plate having an outwardly facing side and an inwardly facing side and which extends along a plate axis between a first plate end and an opposite second plate end. The base plate further including edges extending between the first and second plate ends. The conduit support having a locking clip extending from the inwardly facing side of the base plate to secure the conduit support to the opening in the channel.

According to another aspect of the invention, the clip has opposing clip fingers configured to penetrate the channel opening and lockingly engage with the flanges in the channel opening such that the conduit support is maintained relative to the channel and partially in the channel opening. The base plate is configured to be wider than the locking clip such that in an installed condition, the inwardly facing side of the base plate faces the first and second distal ends of the channel thereby overlapping the channel opening and providing further support.

According to yet other aspects of the invention, the clip fingers can be co-molded with the base plate thereby forming a unified part and can extend the entire length of the conduit support thereby increasing rigidity and the holding force of the support onto the channel.

According to even yet other aspects of the invention, the clip fingers can include opposing finger ridges configured to engage the tips of the flanges of the channel opening to further increase the holding force of the conduit support relative to the channel. Yet even further, the ridges can partially wrap about the flange tips to produce a locking action.

According to another aspect of the invention, the spacing between the ridges and the flange tips can urge the inwardly facing side of the base plate against the distal ends of the associated channel, which can further resist movement of the conduit support relative to the channel.

According to other aspects of the invention, the conduit support can be configured to selective receive separate conduit clips configured to receive and hold a conduit wherein the clip in combination with the conduit support can secure the conduit relative to the channel.

According to yet another aspect of the invention, the conduit clips can include clip flanges having a clip flange thickness and the conduit support can have opposing inwardly facing clip receiving slots with downwardly extending resistance fingers extending toward the outwardly facing surface of the base plate such that the resistance fingers have a bottom extent spaced from the outwardly facing surface by a restricted finger spacing and the restricted finger spacing is less than the flange thickness thereby producing a friction fit between the clip flanges and the conduit support.

According to a further aspect of the invention, the conduit support can include a base plate having a concave portion and the concave portion can be configured to partially flatten when the installed condition by the flexing of the base plate about the plate axis. This can be utilized to maintain a base plate that is not convex, which would impact the fit between the conduit clips and the conduit support in view of the flexing of the conduit support when it is clipped into the opening of the channel.

According to yet another aspect of the invention, the conduit support can further include a reinforcing rib below the concave portion that can work in combination with the concave portion to further reduce any unwanted flexing of the base plate after installation into the installed condition. Further, the reinforcing rib can extends between the opposing clip fingers and between the first and second plate ends.

According to other aspects of the invention, the conduit support can be configured such that the base plate runs parallel with the channel opening and allows the support to be as long as desired wherein many conduit clips and conduits can be supported by one conduit support, which can be important for larger projects. Further, this allows the support to be produced in large lengths and cut to size at the job site. In one embodiment, the conduit support can be greater than 5 inches in length. In others, it can even be greater than 10 inches long.

The clip, whether separate items or co-molded items, can be utilized to secure a wide range of conduits to the channel including both plumbing and electrical conduits. However, while it has been found that the invention works particular well in connection with plumbing and electrical applications, the clips and support of this application can be used for a wide range of conduits including, but not limited to, gas lines and other fluid lines.

### BRIEF DESCRIPTION OF THE DRAWINGS

The foregoing and more, will, in part, be obvious and, in part, be pointed out more fully hereinafter, in connection with a written description of preferred embodiments of the present invention illustrated in the accompanying drawings in which:

FIG. 1 is an exploded perspective view of a conduit support in accordance with certain aspects of the present invention and a metal U-Shaped channel;

FIG. 2 is an end view of the conduit support and channel shown in FIG. 1 in an uninstalled condition;

FIG. 3 is an end view of the conduit support and channel shown in FIG. 1 in an installed condition;

FIG. 4 is a perspective view of an electrical conduit clip;

FIG. 5 is an end view of the conduit clip shown in FIG. 4 with a conduit positioned within the clip;

FIG. 6 is a side view of a conduit clip for plumbing and other smooth-wall conduits;

FIG. 7 is an end view of the conduit clip shown in FIG. 6 with a conduit positioned within the clip;

FIG. 8 is a top view of two conduit clips wherein one of the conduit clips is in position to be secured to the conduit support and the other clip is secured to the conduit support; and,

FIG. 9 is a sectional view taken along line 9-9 in FIG. 8.

### DESCRIPTION OF PREFERRED EMBODIMENTS

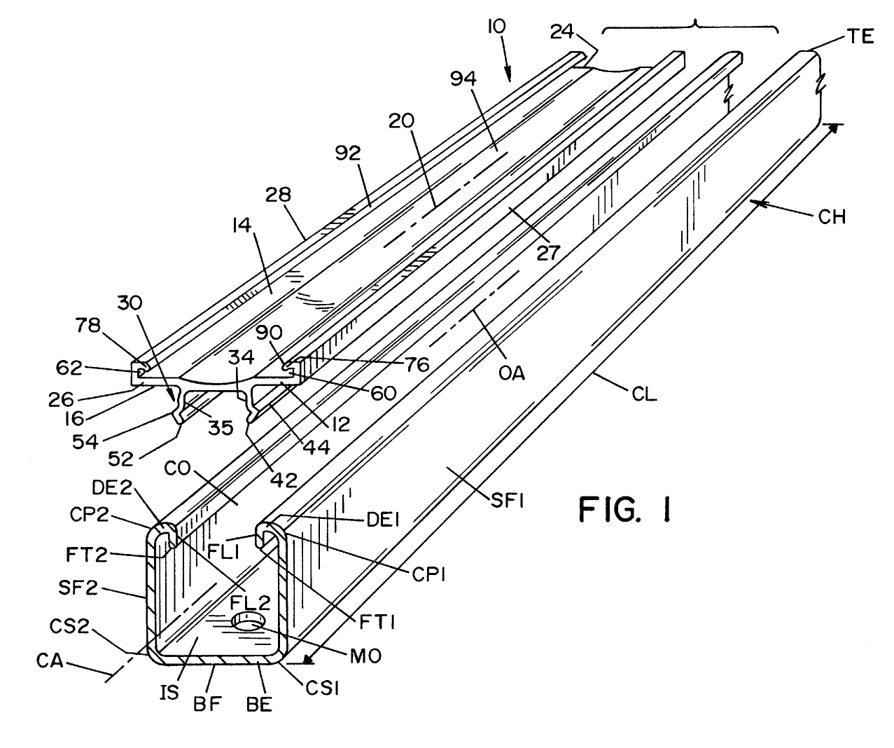

Referring now in greater detail to the drawings, wherein the showings are for the purpose of illustrating preferred embodiments of the invention only, and not for the purpose of limiting the invention, FIGS. 1-3 show both a conduit support 10 and a U-shaped channel CH wherein conduit clip 10 is configured to lockingly engage with channel CH to support one or more conduits relative to a wide range of structural objects and which will be discussed in greater detail blow.

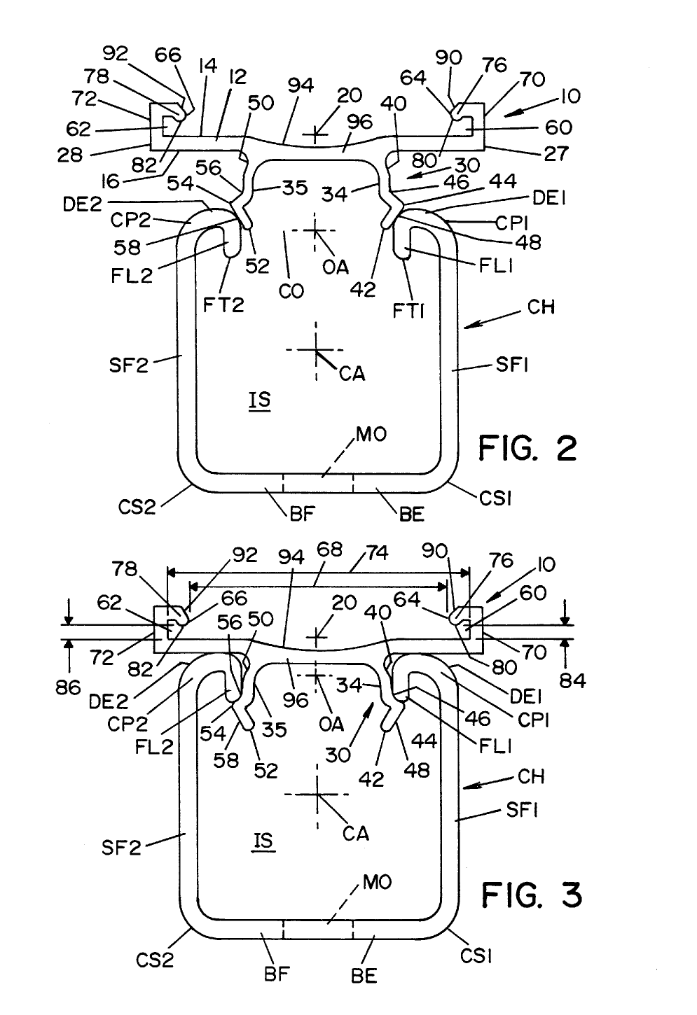

More particularly, channel CH is U-shaped and has a generally rectangular cross-sectional configuration, which is best shown in FIGS. 2 and 3. Channel CH extends linearly along a channel axis CA between a first channel extent CE1 and an opposite second extent CE2 which defining a channel length CL. The U-shaped configuration of the channel is formed by three faces that are generally at right angles to one another. The three faces include a base face BF, a first side or right side face SF1 and a second side or left side face SF2. The first and second side faces extending from either side of the base face and can be joined to base face BF by curved sections CS1 and CS2. First side face SF1 extends from curved section CS1 toward a first distal end DE1 and first distal end DE1 can have a curved portion CP1. Similarly, second side face SF2 extends from curved section CS2 toward a second distal end DE2 and second distal end DE2 can have a curved portion CP2. Curved portions CP1 and CP2 extend toward one another and can in part define a channel opening CO. Channel opening extends linearly along the channel axis and has an opening axis OA that is parallel to but spaced from channel axis CA. Further, both the first and second distal ends can include flanges FL1 and FL2, respectively, that extend inwardly from the distal ends into an inner space IS within channel CH. The first flange has a first flange tip FT1 and the second flange has a second flange tip FT2.

Conduit support 10 has a base plate 12 with an outwardly facing side 14 and an inwardly facing side 16. Base plate 12 extends along a plate axis 20 between a first plate end 24 and an opposite second plate end 26. Base plate further includes edges or sides 27 and 28 that can extend between first end 24 and second end 26. In order to secure the conduit support to the channel, conduit support 10 includes a locking clip 30 that extends inwardly from inwardly facing side or surface 16. Locking clip is configured to lockingly engage with opening CO of channel CH and can utilize a wide range of locking configuration to create the locking engagement. The locking engagement shown includes opposing clip fingers 34 and 35 configured to penetrate channel opening CO of channel CH and lockingly engage with the edges of the channel opening. In this embodiment, fingers 34 and 35 are configured to lock onto flanges FL1 and FL2 that outline the channel opening.

Further, clip fingers 34 can extend from a proximal leg 40 to a finger tip 42 and include a ridge 44 with a ridge curve 46 between proximal leg 40 and ridge 44. In addition, finger 34 can include a lead in taper 48 to aid in the installation of the locking clip into the channel opening. Similarly, finger 35 can extend from a proximal leg 50 to a finger tip 52 and include a ridge 54 with a ridge curve 56 between proximal leg 50 and ridge 54. In addition, finger 35 can include a lead in taper 58 to aid in the installation of the locking clip into the channel opening in combination with taper 48; all of which will be discussed in greater detail below. As is shown, ridges 44 and 54 extend away from one another. Yet further, the inclusion of the curved portions 46 and 56, ridge 44 can partially wrap about flange tip FT1 and ridge 54 can partially wrap about flange tip FT2 thereby increase the locking fit between the conduit support and the channel. Yet even further, the wrapping can be increase such that a significant force is needed to remove the support from the channel. Yet even further, fingers 34 and 35 can include one-way barbs (not shown) to prevent the removal of the support from the channel after it is installed. In yet other embodiments, the engagement between the ridges 44 and 54 and flange tips FT1 and FT2 urges the conduit support inwardly deeper into inner space IS such that surface or side 16 is forced against distal ends DE1 and DE2 which can create a greater stabilizing affect between the conduit support and the channel thereby reducing relative movement between the two components by a resistance or friction fit in addition to the locking fit between lock 30 and opening CO.

The clip and clip fingers can be co-molded with base plate 12 and can extend from first plate end 24 to second plate end 26. By extending the entire distance between the plate ends, the holding force of the conduit support onto the channel is both greatly increased and is proportional to the number of conduits that the conduit support is intended to support wherein greater holding force is achieved for larger or longer conduit supports.

The conduit support can be a molded article and can be manufactured from any material utilized in the industry including, but not limited to, from a polymer, PVC, polycarbonate and aluminum. Further, conduit 10 can be an extruded component and cut to a desired length.

The conduit support is further configured to secure one or more conduit clips and these clips will be discussed in greater detail below. This can be with clips molded or formed into the conduit clip (not shown) or by separate conduit clips that are fastenable to the conduit support wherein conduit support secures the conduit clips relative to the channel and the conduit clips secure the conduit to the conduit support.

With respect to the clips that are secured to the conduit support, the conduit support can further include opposing inwardly facing clip receiving slots 60 and 62 extending upwardly from base plate 12 at or near edges 27 and 28. Clip receiving slots 60 and 62 are shaped to receive a portion of the flanges from the conduit clips that will be discussed more below. Inwardly facing slots 60 and 62 have inner edges 64 and 66, respectively, which face one another and define a conduit clip receiving gap 68, which will also be discussed in greater detail below. Slot 60 and 62 further include side walls 70 and 72 spaced from one another by an end wall spacing 74.

Slots 60 and 62 can further include downwardly extending resistance fingers 76 and 78, respectively, which extend toward the outwardly facing surface of the base plate and which have a bottom extent 80 and 82, respectively, that are spaced from the outwardly facing surface by a restricted finger spacing 84 and 86, respectively. The restricted finger spacing being less than the remaining portions of the slot and is less than the flange thickness of the conduit clips, which will be discussed more below, thereby producing a friction fit between conduit clips and the conduit support. This can be utilized to prevent relative movement between the clips and the support that can further aid the electrician and/plumber in the installation of the conduits and can increase the load that the system s capable of supporting. This in combination with locking clip 30 extending the entire length of support 10 creates a device that can support large loads. Yet further, slots 60 and 62 and/or fingers 76 and 78 can include lead in tapers 90 and 92 to further aid in the installation of the conduit clips.

Conduit support 10 can further include a concave portion 94 on outwardly facing side 14 of base plate 12. This concave portion can be utilized to account for any twisting in the base plate when the conduit support is locked into place in the channel opening. As can be appreciated, the inward forces on the clip fingers could distort the conduit support. By including the concave portion, the base surface of the conduit clips align with surface 14 such that the flanges of the clip, which will be discussed more below, will rest on surface 14 to ease the attachments of the conduit clips to the clip support. While this concave portion is shown as a small central portion generally aligned above the clip fingers, the concave portion can be any concave surface portion and can span surface 14. Yet further, while the concave portion may partially flatten when the conduit support is installed, it may not completely flatten thereby creating a small gap between surface 14 and the bottom of the middle of the clips while allowing the clip flanges to be align with and rest flatly on the upper base surface.

To further increase rigidity and ease the clipping of the clips to the conduit support, the conduit support can include one or more reinforcement ribs 96. This can include rib 96, as shown, which is a downwardly extending rib extending between the clip fingers. This can also prevent unwanted twisting of the base surface from the locking of the conduit support on the channel and/or these ribs can be used for other strengthening of the support for use in the field. Yet even further, rib 96, or the like, can extend between first and second plate ends 26 and 26 to provide support for the entire length of the conduit support.

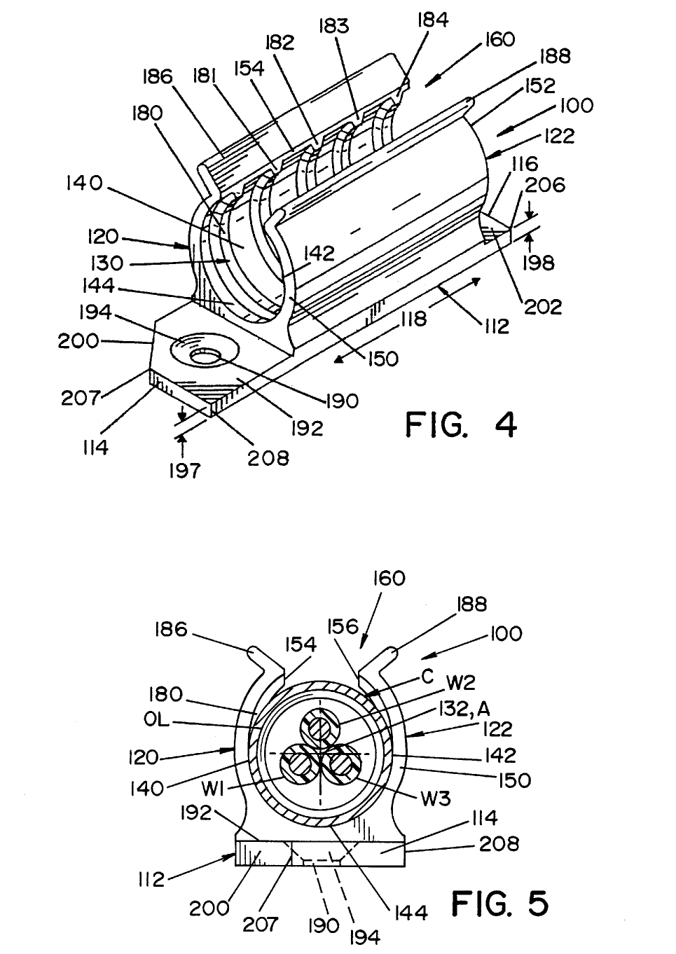

With reference to FIGS. 4-7 shown are clips 100 and 300. With respect to clip 100, this clip is configured to support an MC-cable C. In greater detail, clip 100 has a base portion 112 extending between an end 114 and an end 116 that together define longitudinal direction 118. Clip 100 further includes side walls 120 and 122 that also extend in the longitudinal direction.

Clip 100 further includes a conduit receiving cavity 130 that is oval or C-shaped that can extend from end 114 to end 116, but can be shorter. Cavity 130 is shaped to receive a section of an armored conduit or MC-cable C to secure the conduit to the clip. Cavity 130 extends circumferentially about a cavity axis 132. Cavity 130 is formed at least in part by inner surfaces 140 and 142 of walls 120 and 122, respectively. Inner surface portions 140 & 142 can be joined to one another or can be connected by a base surface portion 144 near base 112. Further, cavity 130 can be a smooth arcuate cavity or can be polygonal such that it is still generally C-shaped. As can be appreciated, and for example only, surface portion 140 or 142 could be formed by a plurality of non-parallel flat surface portions producing a polygonal cross-sectional configuration or could be formed by a unified arcuate surface.

Again, cavity 130 extends longitudinally in direction 118 and is shown to extend between cavity ends 150 and 152. Cavity 130 extends circumferentially between top edges 154 and 156. While cavity 130 is shown to be continuous, cavity 130 does not need to be continuous and could include gaps, mounting arrangements etc. including, but not limited to, a central mounting hole (not shown) in the cavity to secure the clip to a structural object separate from conduit support 10.

Top edges 154 and 156 at least in part form the edges of a top opening 160 sized to allow the conduit to enter cavity 130 with resistance. As can be appreciated, the size of this opening is dependent on the size of the conduit to be inserted. This opening can be a wide range of sizes and in one embodiment, the opening is between 0.23 inches and 0.33 inches and preferable around 0.28 inches when in a relaxed condition as is shown in the FIG. 4. However, clip 100 is made from a material that can flex such that when the conduit is inserted into cavity 130, edges 154 and 156 will move away from one another based on the insertion force of the conduit, which will temporarily enlarge opening 160 and cavity 130. This allows the conduit to be pressed into the clip. Once the conduit is moved through opening 160 and positioned in cavity 130, the clip moves inwardly around the conduit and automatically positions itself into an engaged condition shown in FIG. 5 wherein at least a portion of the inner surfaces engage the conduit.

The conduit can include a central conduit axis A wherein several wires extend generally parallel to this conduit axis. These conduits can be cables that can include three to five wires and as is shown, conduit C includes three wires W1, W2 and W3. Further, these wires can be different gauges. As a result, while many MC cables are standards, there could be different sizes of conduit and, therefore, different clip sizes. Further, the clip can be configured to work in connection with a number of differently sized MC cables and/or conduits, which can require greater flexibility in design and/or materials. The wire are maintained within an outer armored layer OL extending about the conduit axis wherein the outer layer is formed from alternating crowns and troughs that can be helically wound about the conduit axis such that the crowns and troughs are not perpendicular to the conduit axis.

In order to meet some building codes, fastening devices need to secure the conduit such that it can withstand a given pulling load or pull test. Thus, in order to increase pulling resistance, clip 100 can include a rib arrangement on the inner surfaces such as ribs 180-184. However, while five ribs are shown, more or less ribs could be utilized. Further, the ribs can have more than one configuration and each rib does not need to be identical. In this respect, the ribs can extend from near edge 154 to near edge 156 such that the ribs extend about a substantial portion of cavity 30. Further, ribs 180-184 can have a helical slant that is the same or similar to the helical wrapping of certain cables. In this respect, the ribs can be at an angle to the cavity or conduit axis that is not 90 degrees. This configuration can allow the ribs to better engage the crowns and troughs of the conduit. The ribs do not need to extend from edge 154 to edge 156. These ribs could be short ribs that engage a small portion of the crown and trough arrangement of the conduit. Further, the ribs can take other forms (not shown) to work with a wide range of conduits.

These ribs secure conduit longitudinally while the C-shape of the clip maintain the conduit axially. As can be appreciated, the use of ribs in the central portion of the clip requires the sides of the C-shaped portion to flex axially outwardly before the conduit can move substantially longitudinally along the conduit axis. This creates significant pull resistance by the clip without the need for complicated and/or difficult to engage mechanisms. In this respect, prior art clips require the end user to use a tool, either a screw driver or a pair of pliers, to properly secure the clip from movement in the longitudinal direction. Clip can also include clip-opening flanges 186 and 188 near edges 154 and 156 respectively. These flanges can be used to create a ramp-like effect for the conduit to make it easier to force the conduit into the clip. These lead in tapers or clip-opening flanges on the open side of the C-shaped portion allow the clip to be opened by merely pushing the conduit axially against the open side of the C-shaped portion. The conduit will drive the sides of the C-shaped section away from each other until the conduit enters the clip, and then the walls will return toward their natural state. As can be appreciated, the walls may not reach their natural state when they reach the engaged condition, which can be used to increase the gripping force on the conduit.

While clip 100 can include a mounting hole 190 with a countersink portion 194 on an axially extending flange 192, the invention of this application relates to the use of a flange locking arrangement configured to lockingly engage the clip to conduit support 10 by use of flange 192 and an oppositely facing flange 202. In this respect, clip 100 includes a corner cut or notch 200 in flange 192 that is opposite of back side flange 202 wherein flanges 192 and 202 have a thickness 197 and 198, respectively. In addition, flange 202 further includes flange corners 204 and 206, and flange 192 can further include flange corners 207 and 208. Clip 100 has a length 199a that. Clip 100 can further include a cattycorner length 199b between corner cut 200 and corner 206. This configuration allows the clip to be twisted into conduit support 10 that will be discussed in greater detail below.

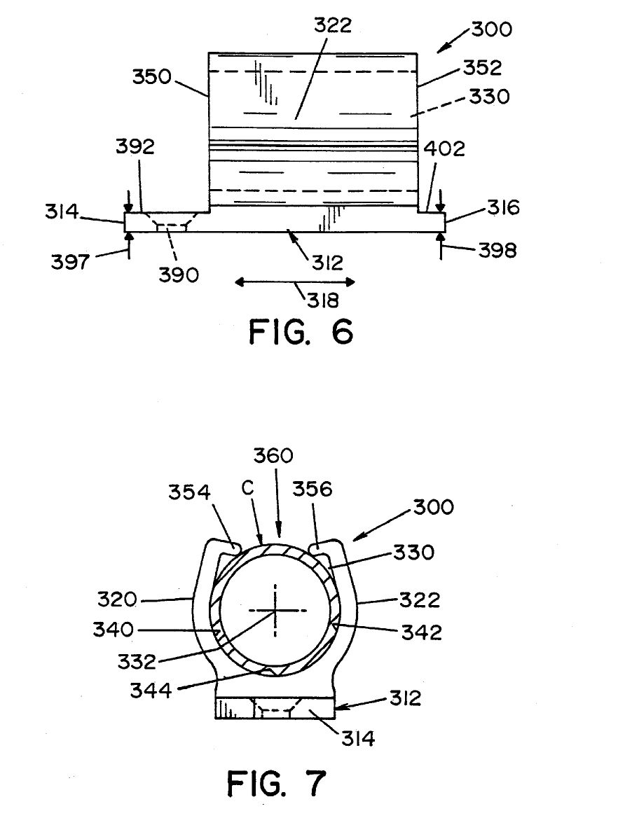

With reference to FIGS. 6 and 7, shown is a clip 300 for pipes and the like. Clip 300 has a base portion 312 extending between an end 314 and an end 316 that together define longitudinal direction 318. Clip 300 further includes side walls 320 and 322 that also extend in the longitudinal direction.

Clip 300 further includes a conduit receiving cavity 330 that is oval or C-shaped that can extend from end 314 to end 316, but can be shorter. Cavity 330 is shaped to receive a section of a conduit C to secure conduit C to the clip such that the clip can be used to support the conduit on a structural object such as conduit support 10. Cavity 330 extends circumferentially about a cavity axis 332. Cavity 330 is formed at least in part by inner surfaces 340 and 342 of walls 320 and 322, respectively. As with other embodiments, inner surface portions 340 & 342 can be joined to one another or can be connected by a base surface portion 344 near base 312. Further, cavity 330 can be a smooth arcuate cavity or can be polygonal such that it is still generally C-shaped. As can be appreciated, and for example only, surface portion 340 or 342 could be formed by a plurality of non-parallel flat surface portions producing a polygonal cross-sectional configuration or could be formed by a unified arcuate surface.

Again, cavity 330 extends longitudinally in direction 318 and is shown to extend between cavity ends 350 and 352. Cavity 330 extends circumferentially between top inwardly facing barbs 354 and 356. While cavity 330 is shown to be continuous, cavity 330 does not need to be continuous and could include gaps, mounting arrangements etc. including, but not limited to, a central mounting hole (not shown) in the cavity to secure the clip to a structural object which will be discussed in greater detail below.

Barbs 354 and 356 can at least in part form the edges of a top opening 360 sized to allow the conduit to enter cavity 330 with resistance. As can be appreciated, the size of this opening is dependent on the size of the conduit to be inserted. This opening can be a wide range of sizes and can be sized based on the size of the conduit to be secured. However, clip 300 is made from a material that can flex such that when the conduit is inserted into cavity 330, barbs 354 and 356 move away from one another based on the insertion force of the conduit, which will temporarily enlarge opening 360, and cavity 330. This allows the conduit to be pressed into the clip. Once the conduit is moved through opening 360 and positioned in cavity 330, the clip moves inwardly around the conduit and automatically positions itself into an engaged condition, as is shown in FIG. 7 wherein at least a portion of the inner surfaces engage the conduit which will be discussed in greater detail below.

Clip 300 can include a mounting hole 390 on an axially extending flange 392 that is offset from the C-shaped portion of the clip. Clip 300 also has a back side flange 402 wherein flanges 392 and 402 have a thickness 397 and 398, respectively Clip 300 further includes a corner cut arrangement as discussed above with reference to clip 100 wherein it will not be discussed in detail for clip 300 in the interest of brevity.

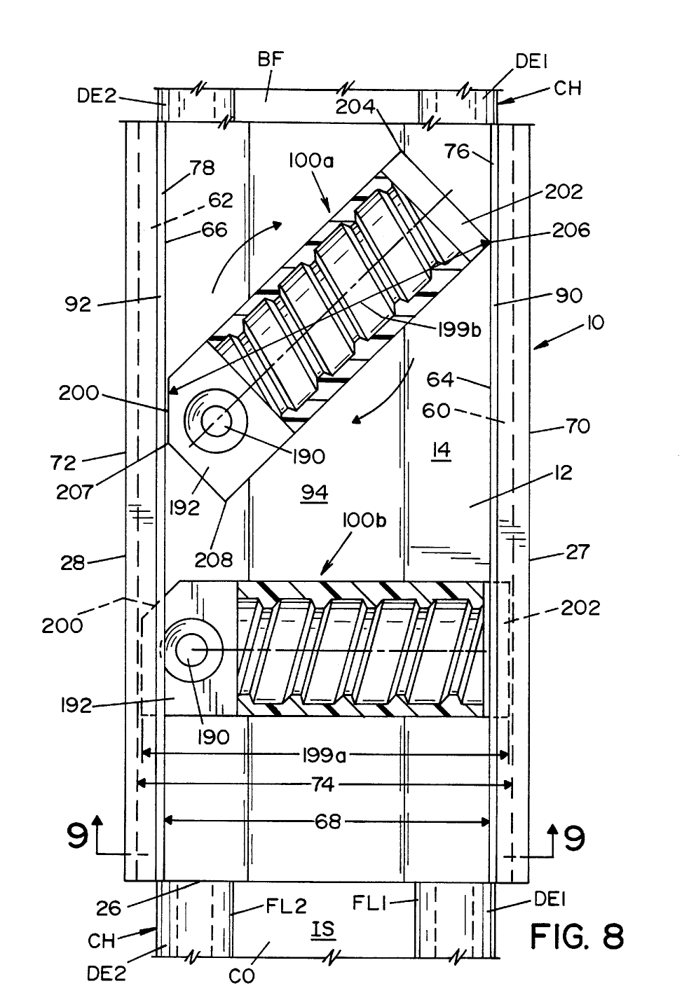

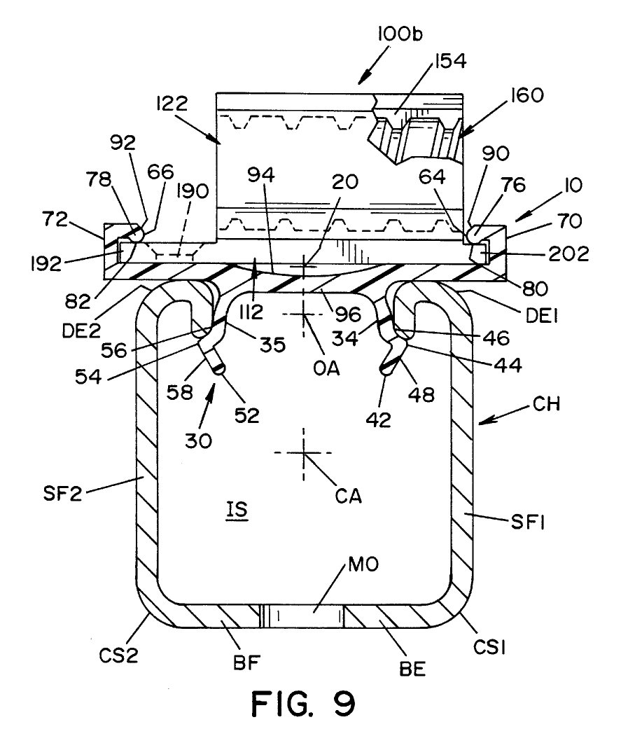

With reference to FIGS. 8 and 9, shown are conduit support 10, channel CH, clips 100a and 100b. While clips 100 are shown in this example, clips 100 and/or 300 could be used interchangeably and one or more clips could be utilized. As can be appreciated, for longer conduit supports, many clips 100, 300 could be utilized.

As discussed above, conduit support 10 includes base plate 12 and opposing slots 60 and 62 extending upwardly from the base plate 12 that are at or near edges 27 and 28. These slots are shaped to receive a portion of one of the flanges from the conduit clips 100, 300 that have flanges lockable within the conduit support which will be discussed in greater detail below with relation to clip 100. Again, inwardly facing slots 60 and 62 have inner edges 64 and 66, respectively, which face one another and define a conduit clip receiving gap 68. Slot 60 and 62 further include side walls 70 and 72 spaced from one another by an end wall spacing 74.

In a preferred embodiment, slots 60 and 62 can further include downwardly extending resistance fingers 76 and 78, respectively, which extend toward the outwardly facing surface of the base plate and which have bottom extents 80 and 82, respectively, that are spaced from the outwardly facing surface by restricted finger spacing 84 and 86, respectively. The restricted finger spacing being less than the remaining portions of the slot and is less than the flange thickness of the conduit clips, thereby producing a friction fit between conduit clips and the conduit support. This can be utilized to prevent relative movement between the clips and the support that can further aid the electrician and/plumber in the installation of the conduits (by maintaining the clip in the desired location and/or alignment) and can increase the load that the system is capable of supporting. This in combination with locking clip 30 extending the entire length of support 10 creates a device that can support large loads. Yet further, slots 60 and 62 and/or fingers 76 and 78 can include lead in tapers 90 and 92 to further aid in the installation of the conduit clips.

In operation, conduit support is first secured to a desired channel CH in a desired position. The channel can be positioned anywhere in the building site including the channel being hung from the ceiling within the building wherein the channel opening can be facing up, down and/or sideways. In this respect, channel CH can include one or more mounting openings MO to secure the channel directly to a wide range of structural object and/or hang the channel from a structural object (such as a ceiling) from one or more hanging devices (not shown). Once in place on channel CH, a desired number and type of clips can be secured to the conduit support. As is shown with respect to clip 100a, the clip is first oriented so that notch 200 is in line with one of edges 27, 28 to allow flanges 192 and 202 to pass inner edges 64 and 66 and rest on surface 14. Once in this position, clip 100a is rotated clockwise to lock the clip in place. In that conduit support includes downwardly extending resistance fingers 76 and 78 that create a gap smaller than the thickness of the flanges, fingers 76 and 78 engage the flanges and are urged upwardly thereby producing a resistance fit between the fingers and the flanges. Continued rotation of the clip in the clockwise direction will then lock the clip in place as is shown by clip 100b. In view of the concave surface portion, the bottom of clip 100 should generally rest directly on surface 14 thereby creating good alignment with downward fingers 64 and making the rotation resistance of the clockwise locking rotation consistent from one clip to the next. If this alignment was inconsistent, some clips could be difficult to lock in place while others could be too loose. The same is true with reinforcement rib 96 that can also be utilized to stabilize the shape of upward surface 14 and make clip installation more reliable and consistent.

Once the clips are in place on conduit support 10, the conduits can be easily snapped into place in the clips to secure the conduits relative to channel CH and, for example, hang the conduits from the ceiling.

While considerable emphasis has been placed on the preferred embodiments of the invention illustrated and described herein, it will be appreciated that other embodiments and/or equivalents thereof can be made and that many changes can be made in the preferred embodiments without departing from the principals of the invention. Accordingly, it is to be distinctly understood that the foregoing descriptive matter is to be interpreted merely as illustrative of the invention and not as a limitation. Furthermore, even though the clips axes are shown to be transverse to the plate axis, this is not a requirement and they could be parallels and/or in other alignments.

Having thus described the invention, it is so claimed:

1. A conduit support for securing one or more conduits to a U-shaped channel support that is generally rectangular in cross-sectional configuration and extends linearly along a channel axis between a first channel extent and an opposite second channel extent defining a channel length, the U-shaped channel being formed by three faces generally at right angles to one another, the three faces including a base face, a first side face and a second side face, the first and second side faces extending from either side of the base face toward a first and a second side distal end respectively, the first and second side distal ends having first and second inwardly curved portions respectively generally extending toward one another and partially defining a channel opening extending linearly between the first and second channel extents and having an opening axis parallel to and spaced from the channel axis, the first distal end having a first flange and the second distal end having a second flange extending into an inner space within the U-shaped channel, the first flange having a first flange tip and the second flange having a second flange tip, the conduit support comprising a base plate having an outwardly facing side and an inwardly facing side and the base plate extending along a plate axis between a first plate end and an opposite second plate end, the base plate further including edges extending between the first and second plate ends, the conduit support further comprising a locking clip extending from the inwardly facing side and having opposing clip fingers configured to penetrate an associated channel opening of an associated U-shaped channel and lockingly engage with the associated channel thereby securing the conduit support relative to the associated U-shaped channel in an installed condition, when in the installed condition, the inwardly facing side of the base plate facing the associated first and second distal ends of the associated channel, the conduit support further including at least one conduit clip shaped to receive and secure an associated conduit relative to the associated channel.

2. The conduit support of claim 1, wherein the clip fingers extend from the first plate end to the second plate end.

3. The conduit support of claim 2, wherein the clip fingers are co-molded with the base plate thereby forming a unified part.

4. The conduit support of claim 1, wherein the clip fingers is a first finger and a second finger and the first finger including a first ridge and the second finger includes a second ridge, the first and second ridged extending away from one another and being configured to engage an associated first and second flange tip respectively.

5. The conduit support of claim 4, wherein the first ridge partially wraps about the associated first flange tip and the second ridge partially wraps about the second associated flange tip.

6. The conduit support of claim 5, wherein the engagement between the first and second ridges and the associated first and second flange tips urges the inwardly facing side of the base plate against the associated first and second distal ends of the associated channel.

7. The conduit support of claim 1, wherein the at least one conduit clip shaped to receive and secure the associated conduit relative to the associated channel includes a conduit clip securable to the conduit support having a longitudinally extending clip body extending between a first and a second clip end thereby defining a clip length, the conduit clip further including a conduit receiving cavity, a first longitudinally extending flange at the first end and a second longitudinally extending flange at the second end, the first flange having a first transverse outer edge at least partially defining the first end and the second flange having a second transverse edge at least partially defining the second end, the first flange further including a first corner portion and a second corner portion, the second flange including a third corner portion and a forth corner portion such that the first corner portion is cattycornered to the third corner portion defining a clearance length of the clip and the second corner portion is cattycornered to the forth corner portion defining a locking length of the clip, the clearance length being less than the locking length, the conduit support further including opposing inwardly facing clip receiving slots extending upwardly from the base plate, each clip receiving slots being shaped to receive a portion of one of the flanges, the inwardly facing slots each having inner edges facing one another thereby defining a conduit clip receiving gap, the each slot further including side walls spaced from one another by an end wall spacing, the clearance length being less than the end wall spacing such that the clip can be received in the clip receiving gap and the locking length being greater than the end wall spacing wherein the clip can be rotated relative to the strap to substantially lock the clip relative to the strap.

8. The conduit support of claim 7, wherein the first and second flanges have a flange thickness, each of the opposing inwardly facing clip receiving slots further including a downwardly extending resistance finger extending toward the outwardly facing surface of the base plate, the resistance fingers having a bottom extent spaced from the outwardly facing surface by a restricted finger spacing, the restricted finger spacing being less than the flange thickness thereby producing a friction fit between first and second flanges and the conduit support.

9. The conduit support of claim 8, wherein the downwardly facing fingers are inwardly spaced from the side walls.

10. The conduit support of claim 1, wherein the outwardly facing side of the base plate includes a concave portion.

11. The conduit support of claim 10, wherein the concave portion extends between the first and second plate ends.

12. The conduit support of claim 11, wherein the concave portion partially flattens when in the installed condition by the flexing of the base plate about the plate axis.

13. The conduit support of claim 11, wherein the base plate further includes a reinforcing rib below the concave portion.

14. The conduit support of claim 13, wherein the reinforcing rib extends between the opposing clip fingers and between the first and second plate ends.

15. The conduit support of claim 1, wherein the base plate further includes a reinforcing rib, the reinforcing rib extending between the opposing clip fingers and between the first and second plate ends.

16. The conduit support of claim 1, wherein the conduit support has a length between the first and second plate ends, the length begin greater than 5 inches.

17. The conduit support of claim 1, wherein the conduit support has a length between the first and second plate ends, the length begin greater than 10 inches.

18. The conduit support of claim 1, wherein the conduit support has a length between the first and second plate ends, the length is between about 8 and 16 inches.

19. The conduit support of claim 1, wherein the clip fingers extend from the first plate end to the second plate end and are co-molded with the base plate thereby forming a unified part, the clip fingers being a first and a second finger and the first finger including a first proximal leg joined to the base plate and a laterally extending first ridge with a first curved portion therebetween, and the second finger includes a second proximal leg joined to the base plate and laterally spaced from the first proximal leg and a laterally extending second ridge wherein the first and second ridges extend away form one another, the second finger further including a second curved portion between the second proximal leg and the second ridge, the first curved portion and first ridge partially wrapping about the associated first flange tip and the curved portion and second ridge partially wrapping about the second associated flange tip when in the installed condition, the engagement between the first and second curved portions and ridges and the associated first and second flange tips urging the inwardly facing side of the base plate against the associated first and second distal ends of the associated channel.

20. The conduit support of claim 1, wherein the at least one conduit clip shaped to receive and secure the associated conduit relative to the associated channel includes a conduit clip securable to the conduit support having a longitudinally extending clip body extending between a first and a second clip end thereby defining a clip length, the conduit clip further including a conduit receiving cavity, a first longitudinally extending flange at the first end and a second longitudinally extending flange at the second end, the first flange having a first transverse outer edge at least partially defining the first end and the second flange having a second transverse edge at least partially defining the second end, the first flange further including a first corner portion and a second corner portion, the second flange including a third corner portion and a forth corner portion such that the first corner portion is cattycornered to the third corner portion defining a clearance length of the clip and the second corner portion is cattycornered to the forth corner portion defining a locking length of the clip, the clearance length being less than the locking length, the conduit support further including opposing inwardly facing clip receiving slots extending upwardly from the base plate, each clip receiving slots being shaped to receive a portion of one of the flanges, the inwardly facing slots each having inner edges facing one another thereby defining a conduit clip receiving gap, the each slot further including side walls spaced from one another by an end wall spacing, the clearance length being less than the end wall spacing such that the clip can be received in the clip receiving gap and the locking length being greater than the end wall spacing wherein the clip can be rotated relative to the strap to substantially lock the clip relative to the strap, the first and second flanges have a flange thickness, each of the opposing inwardly facing clip receiving slots further including a downwardly extending resistance finger extending toward the outwardly facing surface of the base plate, the resistance fingers having a bottom extent spaced from the outwardly facing surface by a restricted finger spacing, the restricted finger spacing being less than the flange thickness thereby producing a friction fit between first and second flanges and the conduit support.

21. The conduit support of claim 20, wherein the downwardly facing fingers are inwardly spaced from the side walls and the outwardly facing side of the base plate includes a concave portion extending between the first and second plate ends, the concave portion partially flattening when in the installed condition by the flexing of the base plate about the plate axis.

22. The conduit support of claim 21, wherein the base plate further includes a reinforcing rib below the concave portion, the reinforcing rib extends between the opposing clip fingers and between the first and second plate ends.

23. The conduit support of claim 21, wherein the plate axis is parallel to the associated channel axis when in the installed condition.
